(19) United States
(12) Patent Application Publication
(10) Pub. No.: US 2025/0156578 A1
(43) Pub. Date: May 15, 2025

(54) Novel Systems And Methods Of Privacy, Tracking, Surveillance, And Location Information, Aggregation, Combination, Analysis, Processing, Usage, History, Data Monitoring, Control, And Correction.

(71) Applicant: Marc Gittleman, Altadena, CA (US)

(72) Inventor: Marc Gittleman, Altadena, CA (US)

(21) Appl. No.: 15/268,601

(22) Filed: Sep. 18, 2016

Related U.S. Application Data
(60) Provisional application No. 62/220,989, filed on Sep. 19, 2015.

(51) Int. Cl. G06F 21/62; G06F 8/30

(52) U.S. Cl. CPC G06F 21/6245; G06F 8/30; G06Q 30/018

(57) ABSTRACT

This patent creates novel systems and methods of privacy, tracking, surveillance, and location information, aggregation, combination, analysis, processing, usage, history, data monitoring, control, and correction.

### RELATED APPLICATIONS

The present Application claims priority to U.S. Provisional Application 62/220,989.

### BACKGROUND

The invention relates to the field of privacy and/or location history monitoring and control and, in particular, to a method for monitoring, auditing, correcting and control of an User's privacy and/or location history by use of the Internet, phone, mail, in person, and other means. This is meant to be broad, as this information, nor the process, nor the entities described herein (other than certain entities that collect location data in offering other unrelated services) are not and have never been available. This application, and the processes contained herein is the foundation of the privacy and location history, protection, and monitoring industry.

There currently exists no prior art, means, method nor technology for an individual or group of individuals (User) to obtain, aggregate, correlate, monitor, nor correct User's privacy and/or location history and/or monitoring and associated information.

### SUMMARY

Method, means, structure, systems, reporters and bureaus are created herein, and provide for requesting a privacy and/or location history report to one and/or each other privacy reporting bureau, the means to monitor this information, and/or correct it, and the means to aggregate, compile, and/or otherwise process this information.

Once a privacy/location/surveillance/monitoring report is obtained and a discrepancy or error is found in the information, the individual can request investigation of the discrepancy or erroneous privacy and/or location history monitoring either through the privacy and/or location history bureau or directly to the offending privacy and/or location history reporter and/or grantor organization, such as a public location, any monitored location, cellular provider, biometric ID, DNA, department store or bank, as examples. Examples of the type of information that would trigger a report are out-of-habit/pattern items, locations set by the individual as derogatory items/locations, geo-tagged, geo-fenced, and whether a third party requested a privacy and/or location history report.

Thus, it is a goal of the invention to provide a method of on-line and off-line privacy and/or location history monitoring, control, aggregation, and processing.

It is another object of the invention to provide an on-line privacy and/or location history monitoring method that allows an individual to obtain the individual's privacy and/or location history report from the privacy and/or location history reporting bureaus, to address inconsistencies or mistakes in the privacy and/or location history report, and to start time and date stamped reports to affected reporters and/or bureaus to request corrective action.

It is another purpose of the invention to deliver an on-line privacy and/or location history monitoring method that permits an individual who finds or suspects identity theft to initiate time and date stamped notifications to affected reporters and/or bureaus and cognizant government agencies.

It is a further object of the system to provide an on-line privacy and/or location history monitoring method which allows an individual to access time and date stamped notifications initiated by the individual to affected reporters and/or bureaus and government agencies.

Another object of the invention is to provide an on-line privacy and/or location history monitoring procedure that can conclude the hypothetical interest and/or other rate and/or cost that an individual should pay for a specific type of good and/or service based on the individual's privacy and/or location history monitoring, activity, score, or other data.

### DRAWINGS

These and other features, aspects and advantages of the present invention will become better understood with regard to the following description, appended claims, and accompanying figures where:

FIG. 1 illustrates various modalities to register.

FIG. 1A is a computer terminal screen which an individual can log-in or register as a new member. This screen includes general information and additional information for a new member. This screen includes security information.

FIG. 1B is the process for an individual to register via telephone. This includes general information and additional information for a new member and includes security information.

FIG. 1C is the process for an individual to register via mail. This includes general information and additional information for a new member and includes security information.

FIG. 1D is the process for an individual to register in-person. This includes general information and additional information for a new member and includes security information.

FIG. 2 is a computer terminal screen presenting the member with program options.

FIG. 2A is a flow chart of the Monitoring Service Process including requesting privacy and/or location history reports and privacy and/or location history score, and the display of such information.

FIG. 2B is a flow chart of the Reporting Service Process including requesting privacy and/or location history reports and privacy and/or location history score, and the display of such information.

FIG. 2C is a computer terminal screen displaying a process and form to report/correct an inaccuracy in a privacy and/or location history report including displaying a form letter to a reporter, grantor and/or bureau.

FIG. 3 is the two-way Data aggregation and update process to gather Data from providers, bureaus, and other entities, populating System Data, and pushing corrections to providers.

### DETAILED DESCRIPTION

As appropriate, the terms bureau, repository, reporting agency, reporter, service, singular and plural, and associated services and entities described shall be used interchangeably, and shall not be restrictive of one another in the absence of another.

The invention is a method of on-line privacy and/or location history monitoring and control designed to provide an individual with the ability to maintain the individual's privacy and/or location history monitoring for the purpose of protecting against errors and misuse, and for informing and making available to the individual the highest quality available privacy and/or location history consistent with the individual's privacy and/or location history monitoring history and data. In general, the system and method allows an individual using the individual's own, or any, computer terminal to access a computer system in a computer network, such as the Internet, or via phone, mail, or in person, to monitor, request, and record within the computer system, numerous actions initiated by the individual regarding the individual's own privacy and/or location history monitoring.

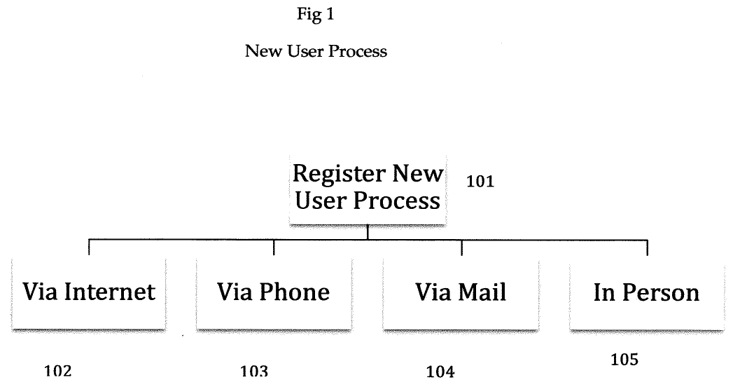

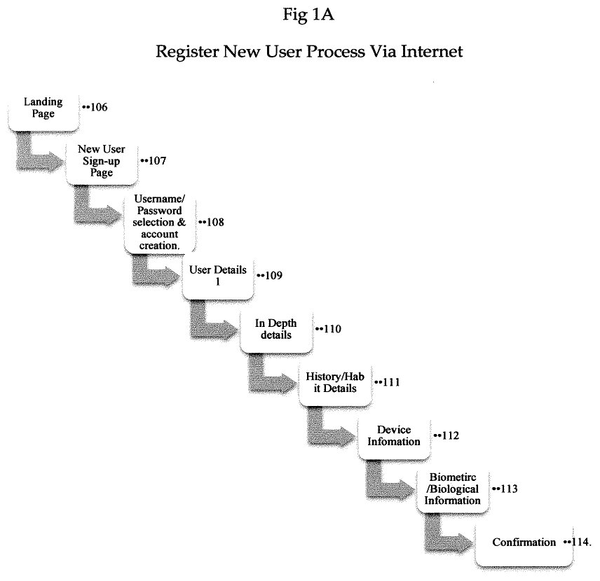

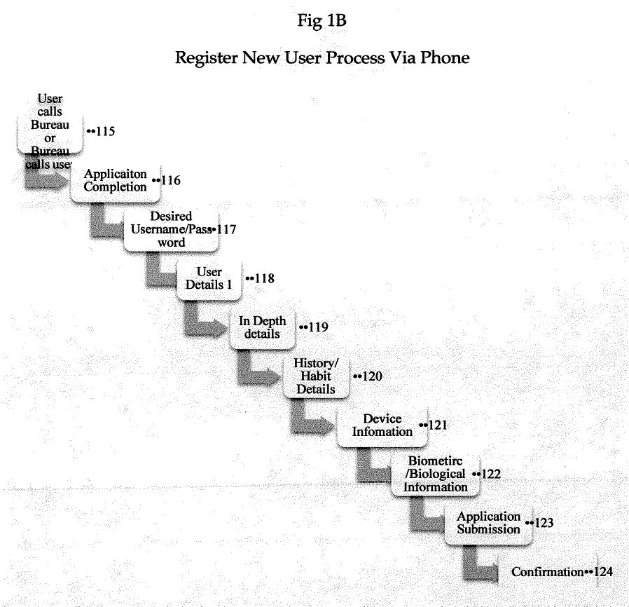

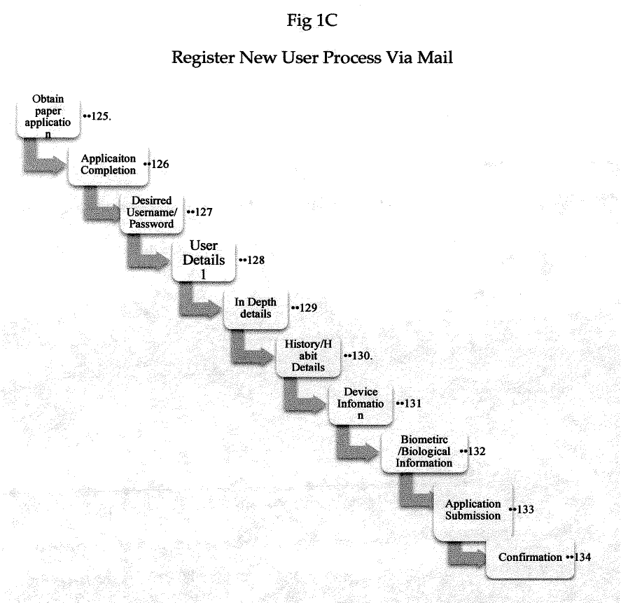

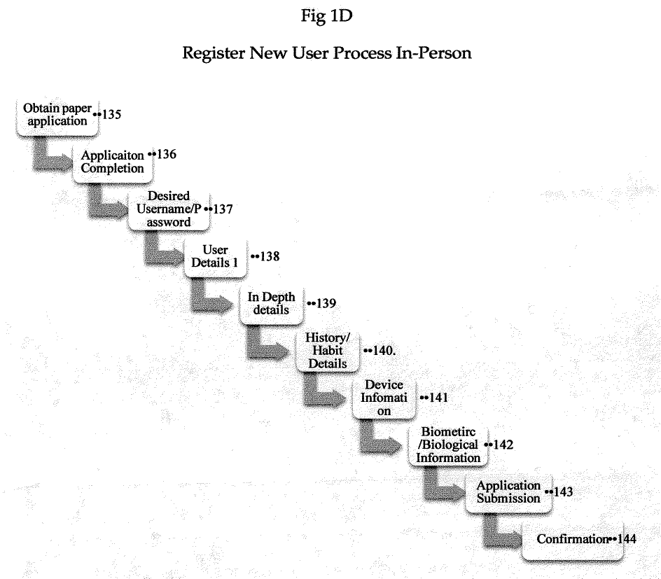

As seen in FIG. 1, a method of on-line monitoring and control of an individual's privacy and/or location history and monitoring, which includes the steps of: 1. The individual accesses a computer system in a computer network or reporter or grantor directly, 101. This is typically accomplished by the individual accessing the Internet 102 by use of the individual's own computer and contacting the privacy and/or location history management computer system or via mail 104, phone 103, or in person 105.

FIG. 1A illustrates how a user may register via Internet. First the user will find a landing page 106, wherein user follows link or enters URL for bureau web site. Then the user will fill out a “New User Sign-up Page” 107, wherein the user initiates process to register. At this page a user must fill out a username/password selection 108. After the user has completed a profile, the user will enter their personal details 109, basic biographical user information gathered followed by more in depth details 110, such as specific personal info gathered (ex: residences, workplace, family members). Further details such as history/habit 111 can also be entered by the user; it is an in-depth selection and gathering of users habits, locations. Next, the user will enter the individual device information 112, tracking info for all user devices (ex: phone, car, computer, tablet, email, browser, wireless/wi-fi, implanted and/or external tracking devices, etc.) The user will then be asked to enter biometric/biological information 113, information on all biological data, DNA, retina, fingerprint, etc. Finally, the user will receive a confirmation 114 of the registration process. The process of gathering information does not require a specific order and the order in which is described herein is merely illustrative, for example, biometric data may be obtained before background information, or even omitted entirely from the process.

FIGS. 1B through 1D illustrate the different ways in which a user may register whether it is via phone, mail or in person. Nevertheless, the background data and collection process is identical in all methods. In FIG. 1B, the registration process is begun by the user calling a bureau 115, or the bureau contacting the user, from which an application 116 is completed. FIG. 1C illustrates the method in which a user obtains a paper application 125 that is completed 126 and mailed. FIG. 1D illustrates the method in which a user obtains a paper application 135 and completes the application 136 and returns the application in person.

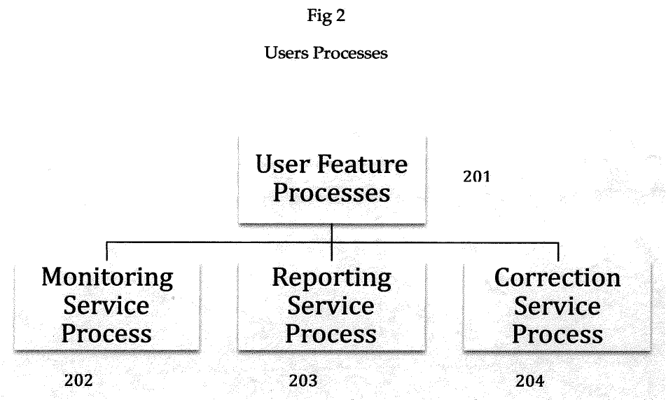

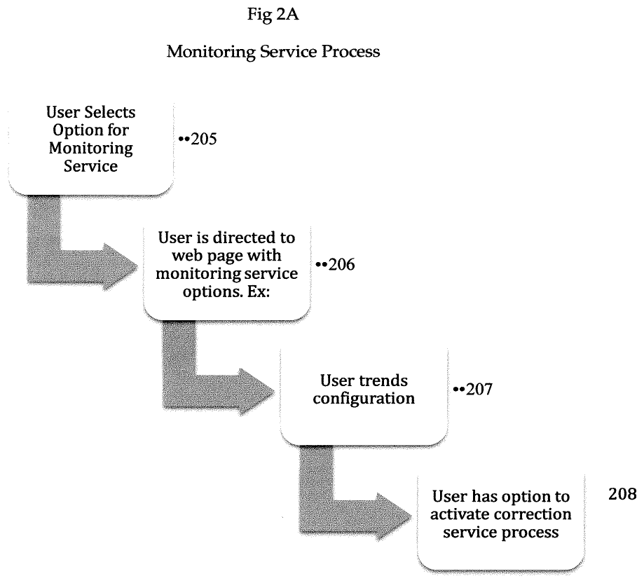

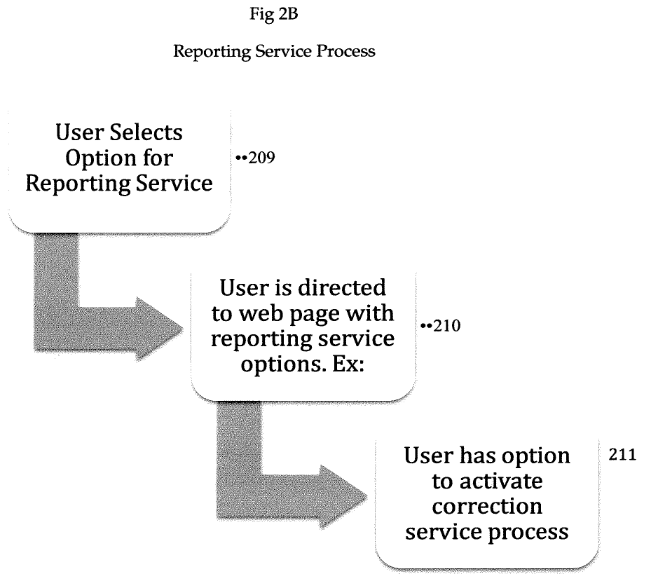

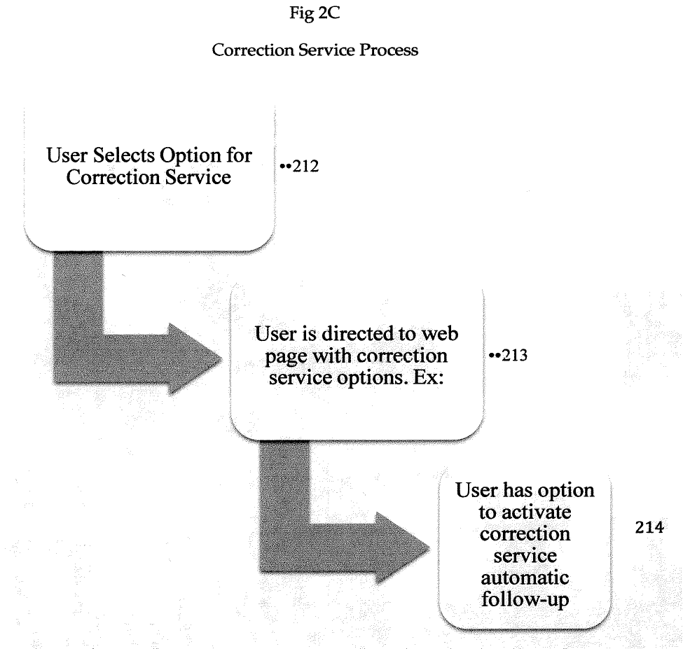

As seen in FIGS. 1A through 1D, after the user has accessed the individual's privacy monitoring via the computer system, mail, phone or in person, the individual then requests actions regarding the individual's privacy and/or location history monitoring as seen in FIG. 2. As seen in FIG. 2 the user feature processes 201 include monitoring services 202, reporting services 203, and correction services 204. These actions may include obtaining a copy of the individual's privacy and/or location history report from any bureau(s), or a combined copy in a consolidated format that displays the data from each of the bureau(s). These actions will also include notification of specific items of the privacy and/or location history report, such as: privacy and/or location history monitoring from grantors, reporters and/or bureaus that can have an effect on the individual's privacy and/or location history, requests from third parties for copies of the individual's privacy and/or location history report, and changes of address as reported to the bureaus and/or grantors. As seen in FIG. 2A, the monitoring service process begins when the user selects the option for monitoring services 205 either during sign-up or subsequent login. The user is then directed to a web page with monitoring services options 206 such as but not limited: location tracking and history as reported/per database, alerts if a location is detected by bureau or any reporter, device, etc., user can configure preset or custom alerts and users can select automatic email/text/push or other auto-notification. Furthermore, the monitoring service provides for user trend configurations 207 wherein the user selects accurate data points from existing reporting data or the user enters new data to define trends. Even more, the user has the option to activate correction service processes 208.

As seen in FIG. 2B the user may also choose a reporting service process 209. After selecting a reporting service process, the user is directed to a web page with reporting service options 210 such as but not limited to where a user is presented options to view reporting of location and or privacy data reporter, users sets alerts if a location is detected by bureau or any reporter, device, etc., user can configure preset or custom alerts, or a user can select automatic email/text/push or other auto-notification. Lastly, the user has an option to activate correction service processes 211.

As seen in FIG. 2C, the user has the option to choose correction service processes 212 at registration or a later time. After selecting a reporting service process, the user is directed to a web page with reporting service options 213 such as but not limited to where the user is presented options to correct location and or privacy data reporter/bureau information, user sets alerts to monitor correction process, user can configure preset or custom alerts, user can select automatic email/text/push or other auto-notification, error correction is issued to reporting party, or the user may choose for the system to automatically check for error correction at a pre-defined interval. Lastly, the user has the option to activate correction service automatic follow-up 214. The correction service provides for the contacting the appropriate organization by the computer system, mail, phone, or in person, and requesting the organization to take appropriate remedial action. Here the computer system or the grantor/bureau/reporter completes the request started by the individual. Through interaction with the bureaus, reporter, or grantor via mail, phone, in person or via computer system, an individual can communicate with a reporter and/or bureau to dispute an information item or items. The individual can also request to be notified electronically, via phone, text, mail or in person the appropriate government agencies should an identity theft situation occur or appear to be imminent such as a co-incidental report of the person in conflicting locations, with an unauthorized address change, or application for privacy and/or location history that the individual did not authorize.

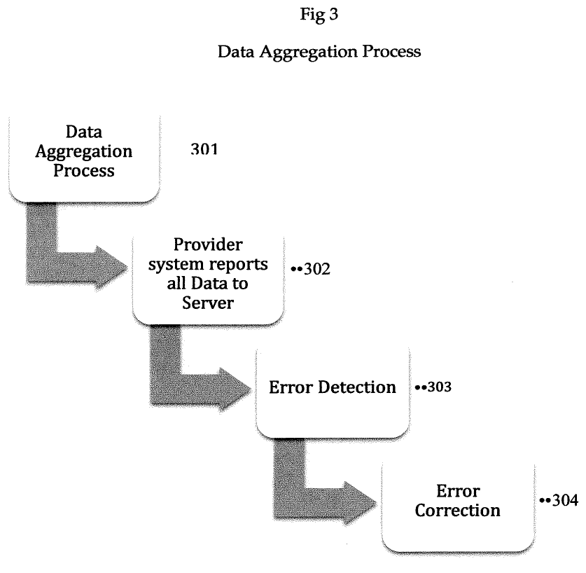

The invention also provides for a data aggregation process 301 as seen in FIG. 3. The service provides system reports and all data to a server 302 wherein the provider data is sent to Server, the server processes and analyzes data, and the server prepares data for reports and use as described herein. Then the process provides for error detection 303; if an error is identified either by User or by System process, the correction step is completed 304. Error Correction 304 comprises the steps where the system sends correction of Data to provider and the system checks for correction at pre-defined interval.

The invention further includes a computer system programmed to decoding the individual's privacy and/or location history monitoring and providing hypothetical cost of goods and/or services such as interest and/or other cost or rate advice.

The invention further includes a computer program to request privacy and/or location history bureaus to delete inaccurate information if investigation fails to begin within a proscribed period. In addition, a computer program is included that date and time stamps, stores, and maintains all actions taken by the individual, through the interface, as well as by any grantor, monitor, and/or bureau.

Database aggregating information and data relating to “User(s)”: individual, individuals, children, corporations, governments, any other entity, and property. The term User and “individual” both singular and plural, shall be interchangeable through this application. This information includes “Data” that is currently collected, and will be collected in the future by new and existing numerous individual entities, “Monitoring Entities,” including organizations, merchants, retailers, government, cellular carriers, web sites, computers, cellular phones and other consumer electronics, cars, surveillance cameras and microphones, biometric information, medical providers, insurance companies, locations, and other personal property. The Data aggregated is recording, reporting, and monitoring information relating to Users current and historical locations, activity, time, duration, identity, health, patterns, habits, and privacy preferences. This Data represents real-time, delayed, and historical Data.

The code sets and system components identified above are further described and identified as comprising the following (paragraphs 35 through 56):
A Privacy Location History Retrieval Code Set 1 (PLHRCS-1):PLHICS-1 is the privacy and/or location history data retrieval code set to access privacy and/or location history data monitoring relating to a User, the privacy and/or location history data monitoring comprising a one, some, or all privacy items, each privacy and/or location history data item being associated with a specific privacy and/or location history data service and/or instance and/or item;
A privacy and/or location history PLHRCS 1 data retrieval code set computing a privacy and/or location history data score Privacy Score 1 (PS1) of the User based upon the privacy and/or location history data monitoring, and other information processed/gathered by the system;
An interface PLHICS-1, including notices to the User of the score relating to the privacy and/or location history data monitoring and the privacy and/or location history data;
A Privacy Location History Monitor and Storage (PLHMS-1) storage and/or storage code sets, storing the privacy and/or location history data monitoring and the privacy and/or location history score. This storage may be local, remote, distributed, and/or cloud based.
The PLHRCS-1 privacy and/or location history data retrieval code set executed regularly and at scheduled intervals provides updates to the privacy and/or location history data monitoring, and identifies changes in the updated privacy and/or location history data monitoring;
A generated alert sent to the User subsequent to identification;
The PLHRCS 1 comprises an archive that is updated with at least one of the privacy or location history data points and data monitoring information;
The PLHRCS 1 comprises coding for an alert based on at least one of the following: determining, recognizing, or indicating changes in the updated privacy or location history data monitoring.
An option for the User to report identity theft;
The option to report identity theft comprises an interface displaying forms for the User to report identity theft to a myriad parties;
The option to report identity theft provides editable forms to report identity theft to the myriad of parties;
A Cost Rate Code Set 1, CRCS-1, operating on data in the PLHRCS-1 and PLHMS-1 code sets, calculating at least one of interest rates, costs, risks and scoring;
At least one link available to report errors and/or problems of the privacy and/or location history data items;
The data in at least one the PLHRCS-1 and PLHMS-1 is associated with at least one data entry from at least one location history service data services
The link associates with one privacy item via the PLHICS-1 code set, creating a form to contact at least one privacy service and location history service;
The data in at least one the PLHRCS-1 and PLHMS-1 is associated with at least one data entry from at least one location privacy service and location history data producer and data supplier;
The data in at least one the PLHRCS-1 and PLHMS-1 is associated with at least one data entry from at least one location privacy service and location history data bureau.
At least one processor set to execute a plurality of Privacy Location History Monitor and Storage (PLHMS-1) code sets comprising at a minimum: a monitoring service code set PLHMS-1 to recognize differences/changes/deviations in/of privacy and/or location history monitoring received from PLHRCS 1 via a privacy and/or location history data reporter, bureau, or other repository, the privacy and/or location history data associated with an individual;
A Privacy Location History Monitor, Storage and Alert (PLHMS-1A) alert code set configured to alert the User online, via phone, text, email, mail, or/and in person,
An alert message consisting of data associated with the change of information in the privacy monitoring; and
A link in the alert message.

Wherein the link is constructed by the PLHICS-1 code set to begin a communication with and between the individual and a privacy and/or location history issuer related to the link, the alert message set to provide the User with information to communicate directly with the privacy and/or location history data repository/broker.

In a preferred embodiment, a system for tracking the monitoring of privacy and/or location history comprises the following (paragraphs 58 through 62):
A Code Set, the Code Set Interaction Monitor (CSIM-1) analyzing and monitoring the behavior and interaction in, by and between PLHRCS-1, PLHMS-1 and PNMCS-1 code sets;
a computing system that can be accessed by a user via PLHICS-1 Code set;
the computing system comprises one or many processors, privacy and/or location history monitoring in PLHRCS-1 and PLHMS-1 relating to the User or other person/entity, the privacy and/or location history monitoring consisting of a multitude of privacy and/or location history items, each privacy and/or location history item being associated and/or linked to/with a specific or multitude of privacy and/or location history service(s); and
A displayed data set presented as a PLHICS-1 Code set user interface, made up of a one/some/many links in one/some/many web pages and/or other electronic communications, each links being associated with a respective one of the multitude of privacy and/or location history items of PLHRCS-1 or PLHMS-1, with each link enabling the User to communicate directly with one/some/many/all of the privacy and/or location history services in reference to one/some/many/all of the privacy and/or location history items using the link pertaining to the privacy and/or location history item.

The preceding diagrams show the novelty and utility of the inventions claimed in this application. It is specifically understood that the drawings are for purposes of illustration and description only and not meant as a definition of the boundaries of the invention.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

The present invention is described herein with reference to screen shots, block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

1. (canceled)

2. A system comprising at least one server computer and at least one processing unit;
Wherein the Server provides the following list of tasks:
(i) Storage;
(ii) Processing;
(iii) Maintenance;
(iv) Scoring;
(v) Matching via the matching engine; and
(vi) Monitoring,
wherein the system calculates a prediction(s) based on at least one of the following the storage, the processing, the maintenance, the scoring, the matching engine and the monitoring.

3. The system of claim 2 wherein the Server and Database provide for and aggregate and integrate Data from at least one Monitoring Entity.

4. The System of claim 2 wherein the system performs the following functions;
(a) The Server and Database accesses, interacts with, processes, manipulates, predicts, retrieves, monitors, produces, and displays Data, and options to perform on Data including analysis and correction;
(b) The Server analyzes, corrects, predicts, and ascribes probabilities to a myriad of variables and factors including at least one of the following preferences location, risk, habits, tendencies, health, pricing, and other variables;
(c) The Server provides for alerts to changes of Data in various instances and modalities, Server may alert when at least a single or multiple Data or alerts change;
(d) The Server includes the Matching Engine which may alert when a pattern matches a predefined set of criteria including but not limited to any stored Data, Server matching, monitoring, defined pattern, geo fence, risk, Server prediction, and other criteria as available. The alert may be via text, phone, radio, correspondence, mail, email or any other method of automated or manual notification;
(e) The Server provides for correction of Data through interaction and process with Monitoring Entities, reporters, and bureaus;
(f) The Server provides links to Monitoring Entities, reporters and bureaus allowing for interrogation of Data, correction, opt-out, exclusion, monitoring configuration, and removal of at least one of the stored data or User from at least one Monitoring Entity;
(g) The Server provides additional services and options for control, use, monitoring; and manipulation of Data by User or other subscribers data products;
(h) The Server provides identity theft services through analysis of Data, patterns, recognition, habits, and alerts; and
(i) The server provides at least one of the following; Data-related cost and rate calculations, preferences, patterns, and predictions.

5.-11. (canceled)

12. A server/computer of one or more processors to execute multiple software code sets, the software code sets includes at least:
(a) A Privacy Location History Retrieval Code Set 1 (PLHRCS-1):PLHICS-1 is the privacy and/or location history data retrieval code set to access privacy and/or location history data and monitoring relating to a User, the privacy and/or location history data and monitoring comprising a one, some, or all privacy items, each privacy and/or location history data item being associated with a specific privacy and/or location history data service and/or instance and/or item; and
(b) A user interface coded bye the PLHICS-1 interface code set to generate data comprising at least one active link on at least one of the following:
(i) web pages;
(ii) electronic communications;
(iii) conversation; or
(iv) written communication,
wherein each active link is associated with at least one privacy or location history data items thereby enabling the User to communicate directly with at least one one of the privacy or location history data services.

13. The system of claim 12 comprising the following items:
(a) A privacy and/or location history PLHRCS 1 data retrieval code set computing a privacy and/or location history data score Privacy Score 1 (PS1) of the User based upon the privacy and/or location history data monitoring, and other information processed/gathered by the system;
(b) An interface PLHICS-1, including notices to the User of the score relating to the privacy and/or location history data monitoring and the privacy and/or location history data;
(a) A Privacy Location History Monitor and Storage (PLHMS-1) storage and/or storage code sets, storing at least one of the privacy and/or location history data monitoring and the privacy and/or location history items and score. This storage may be local, remote, distributed, and/or cloud based,
(b) The PLHRCS-1 privacy and/or location history data retrieval code set executed regularly and at scheduled intervals provides updates to the privacy and/or location history data monitoring, and identifies changes in the updated privacy and/or location history data monitoring;
(c) A generated alert sent to the User subsequent to identification;
(d) The PLHRCS-1 comprises an archive that is updated with at least one of the privacy or location history data points and data monitoring information;
(e) The PLHMS-1 comprises coding for an alert based on at least one of the following: determining, recognizing, or indicating changes in the updated privacy or location history data monitoring,
(f) An option for the User to report identity theft;
(g) The option to report identity theft comprises an interface displaying forms for the User to report identity theft to a myriad parties;
(h) The option to report identity theft provides editable forms to report identity theft to the myriad of parties;
(i) A Cost Rate Code Set 1, CRCS-1, operating on data in the PLHRCS-1 and PLHMS-1 code sets, calculating at least one of interest rates, costs, risks and scoring;
(j) At least one link available to report errors and/or problems of the privacy and/or location history data items;
(k) The data in at least one the PLHRCS-1 and PLHMS-1 is associated with at least one data entry from at least one location history service data services
(l) The link associates with one privacy item via the PLHICS-1 code set, creating a form to contact at least one privacy service and location history service;
(m) The data in at least one the PLHRCS-1 and PLHMS-1 is associated with at least one data entry from at least one location privacy service and location history data producer and data supplier; and
(n) The data in at least one the PLHRCS-1 and PLHMS-1 is associated with at least one data entry from at least one location privacy service and location history data bureau.

14-26. (canceled)

27. A system to automatically monitor an individual's privacy and/or location history monitoring comprising the following:
(a) At least one processor set to execute a plurality of Privacy Location History Monitor and Storage (PLHMS-1) code sets comprising at a minimum: a monitoring service code set PLHMS-1 to recognize at least one of a differences/changes and deviations in/of privacy and/or location history monitoring received from PLHRCS 1 via a privacy and/or location history data reporter, bureau, or other repository, the privacy and/or location history data associated with an individual;
(b) A Privacy Location History Monitor, Storage and Alert (PLHMS-1A) alert code set configured to alert the User online, via phone, text, email, mail, or/and in person,
(c) An alert message consisting of data associated with the change of information in the privacy monitoring; and
(d) A link in the alert message,
Wherein the link is constructed by the PLHICS-1 code set to begin a communication with and between the individual and a privacy and/or location history issuer related to the link, the alert message set to provide the User with information to communicate directly with the privacy and/or location history data repository/broker.

28. The system of claim 27 wherein with the privacy and location history data repository comprises at least one of the following privacy and location history bureaus.

29. The system of claim 27 wherein the privacy or location history issuers include at least one of the following privacy and location history creators and at least one of

30. The system of claim 27 wherein the privacy and location history issuer and creator includes at least one of the following privacy and location history bureaus.

31. (canceled)

32. The system of claim 27 wherein the alert message comprises at least one of the following: web page, electronic, audio, written, and/or in-person communications.

33. The system of claim 27 comprising a network communications code sets (the PNMCS-1) to receive at least one request(s) to monitor privacy and/or location history monitoring of or with the individual or others, comprising identifying information relating to the individual or others. The monitoring service code set may be set to begin a monitoring service in response to the received request.

34. The system of claim 27 wherein the PLHRCS-1 monitoring service comprises in one instance, or periodically gathering, from the privacy and/or location history data repository, privacy or location history monitoring associated with the User or other Users originating at least in part on the identifying information relating to the individual, the privacy and/or location history monitoring comprising one or more privacy and/or location history items associated with privacy and/or location history issuers, wherein the plurality of links are based at least in part upon the one or more privacy and/or location history items.

35. A system for tracking the monitoring of privacy and/or location history comprising the following:
(a) A Code Set, the Code Set Interaction Monitor (CSIM-1) analyzing and monitoring the behavior and interaction in, by and between PLHRCS-1, PLHMS-1 and PNMCS-1 code sets;
(b) a computing system that can be accessed by a user via PLHICS-1 Code set;
(c) the computing system comprises one or many processors, privacy and/or location history monitoring in PLHRCS-1 and PLHMS-1 relating to the User or other person/entity, the privacy and/or location history monitoring consisting of a multitude of privacy and/or location history items, each privacy and/or location history item being associated and/or linked to/with a specific or multitude of privacy and/or location history service(s); and
(d) A displayed data set presented as a PLHICS-1 Code set user interface, made up of a one/some/many links in one/some/many web pages and/or other electronic communications, each links being associated with a respective one of the multitude of privacy and/or location history items of PLHRCS-1 or PLHMS-1, with each link enabling the User to communicate directly with one/some/many/all of the privacy and/or location history services in reference to one/some/many/all of the privacy and/or location history items using the link pertaining to the privacy and/or location history item.

36. The system of claim 35 wherein the link further comprises one or more links to report inaccuracies of at least one of the following privacy or location history items via at least one of the following code sets PLHRCS-1 or PLHMS-1.

37. The system of claim 35 wherein the link is associated with at least one of the following privacy or location history items via at least one of the following code sets PLHRCS-1 or PLHMS-1.

38. The system of claim 35 wherein at least one of the privacy or location history services comprises at least one of the privacy or location history creators or issuers via at least one of the following code sets PLHRCS-1 or PLHMS-1.

39. The system of claim 35 wherein one or more of the privacy or location history services are at least one of the following privacy or location history bureaus via at least one of the following code sets PLHRCS-1 or PLHMS-1.

40. The system of claim 35 further comprising a PLHMS-1 storage device and CSIM-1 code with instructions set up to control the system providing:
(a) Access per PLHRCS-1 and/or PLHMS-1 privacy and/or location history monitoring data relating to a User, the privacy and/or location history monitoring comprising a multitude of privacy and/or location history items, each privacy and/or location history item being associated with a specific privacy and/or location history service;
(b) The generated user display data via PLHICS-1 code set configured to display of a user interface, said user interface comprising a plurality of active links in one or more web pages and/or electronic communications, each one of said active links linked to one of the individual of multitude of privacy and/or location history items of per PLHRCS-1 and/or PLHMS-1, with each link set to enable the User to directly communicate with one of the privacy and/or location history services concerning one of the privacy and/or location history items by selecting the link; and
(c) A supervisor via the PNMCS-1 code set.

41-44. (canceled)

45. The system of claim 3 wherein the Database consists of Data relating to one, several, and the universe of all Users aggregating the data one-way or two-way, wherein the Monitoring Entity reports to the Database;
Wherein the Database manipulates the Monitoring Entity or the Data where all parties mutually interact with one another and third parties in at least one of the following manners:
(a) reporting to;
(b) correcting data;
(c) augmenting; and
(d) monitoring.
